(19) United States
(12) Patent Application Publication
(10) Pub. No.: US 2002/0053032 A1
(43) Pub. Date: May 2, 2002

(54) System and method for secure data transmission

(76) Inventors: William Race Dowling, Brandywine, MD (US); Ray Van Houtte, Reston, VA (US)

Correspondence Address: GREENBERG-TRAURIG, 1750 TYSONS BOULEVARD, 12TH FLOOR, MCLEAN, VA, 22102, US

(21) Appl. No.: 09/859,667

(22) Filed: May 18, 2001

Related U.S. Application Data
(60) Provisional application No. 60/232,629, filed on Sep. 14, 2000.

(51) Int. Cl. H04L 9/00

(52) U.S. Cl. 713/201

(57) ABSTRACT

A system for secure data transmission includes trusted session sub-layer for maintaining a virtual air gap between a plurality of resource requesters and a plurality of resource providers, and a session manager for a transfer of data between the plurality of resource requesters and the plurality of resource providers.

This application claims priority to U.S. Provisional Patent Application No. 60/232,629, filed on Sep. 14, 2000.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

The present invention relates to the field of electronic data storage and transmission, and, more particularly, to secure storage and transmitted of data to users over a network.

2. Discussion of the Related Art

The “Internet” consists of independent, cooperating networks, or “sites,” arranged in a peer-to-peer topology. Such sites communicate with each other via network access points (NAP's), which act as portals to various Internet “backbones.” These backbones, in turn, carry bulk-information via wide-area networks.

The Internet was designed to allow information sharing between various networks, and several competing protocols of various architectures and complexities were initially used to facilitate this communication. As time went on, the International Organization for Standardization (ISO), in an effort to create a more standardized protocol architecture, created the Open Systems Interconnection (OSI) data model. The OSI data model separated network protocol functions into seven self-contained “layers,” with each layer having different responsibilities.

Although the OSI data model is effective for data transmissions, it has some limitations. For example, due to the peer-to-peer topology of the Internet, the OSI data model does not allow for inherent information secrecy and security among sites, nor is there an inherent way to separate sites and resources that are trusted from those that are untrusted, except in very rudimentary ways. Thus, connecting a site to the Internet makes all resources on that site, including Internet-bound and local network traffic, accessible to the public via the Internet as well.

To solve the problem of separating that which is trusted from that which is untrusted, sites connecting to the Internet have taken it upon themselves to enforce security policies for their individual sites via both publicly available and proprietary technologies, including firewalls, bastion hosts, demilitarized zones (DMZ's), and the like. However, these security means have fallen short because virtually all networks employed by businesses today use what is known as a “system-high” mode of operation, in which data and programs both operate at the same security level, subject to the discretion of an individual user (often referred to as DAC, or Discretionary Access Control). Barring deliberate measures by a given employee, both a proprietary memo from a Board of Directors and an e-mailed lunch appointment with a customer are treated the same way by the security mechanisms. Such problems could be solved by adopting what is known as a “compartmented” operations mode using Mandatory Access Controls (MAC's).

However, the infrastructure needed to properly implement MAC's can be very costly in terms of installation, operation, and maintenance, as well as convenience and usability. For example, each site must have access to technical expertise in order to install, maintain, and repair their specific technology implementation. In addition, given the typically limited time and resources devoted to security issues because of political pressures within an organization, full security analyses, which might bring to light implementation-specific security issues, are rarely performed.

As a result of these shortcomings, MAC's are rarely implemented, leaving most sites with DAC-based security. However, DAC creates challenges when a site wishes to restrict internal data access to certain external sites. As a result, most sites either provide resources to the Internet as a whole, or not at all. Obviously, this can be problematic if there is data or an application which a site wishes to provide to a limited subset of the Internet. The problem at the core of the issue is one of proper, trusted identification, in an environment in which even such basic identifiers as a particular computer's Internet Protocol (IP) address may be forged, thereby allowing a malicious intruder to gain access to a system. Without such identification, such sites cannot properly restrict access.

One solution used with limited success in some high-security environments is to use a trusted operating system. Trusted operating systems provide basic security mechanisms and services which allow computers to protect private information by separating users, applications, and files into different categories, as specified in guidelines set forth by the National Security Agency (NSA) of the United States.

The NSA guidelines set forth six trust levels, and requirements for each level. Although many of the traditional operating systems in use by commercial institutions today implement some form of rudimentary trusting scheme, most require additional software to properly implement guidelines specified by the NSA. However, such software may prevent the operation of some business-critical applications. Short of the sudden widespread appearance of business applications running on trusted operating systems, there is no viable way to implement such trusted operating systems and still maintain the functionality required by Internet connected businesses.

In addition, protecting data under the “system-high” mode using MAC's has yet to see broad industry adoption. The two most commonly used implementation strategies involve encryption using Pretty Good Privacy (PGP) or some other Public Key Infrastructure (PKI) system, and total separation of the network (also called an “air-gap”).

PKI is a system in which an entity, such as a user, a computer, or a company, is assigned both a private key and a public key. A sender may use a combination of a receiver's public key and the sender's private key to encrypt data, and a receiver may use a combination of the sender's public key and the receiver's private key to decrypt the data. Although PKI has been gaining momentum, several issues have prevented widespread adoption of PKI-based systems. For example, PKI requires that all parties involved in a given correspondence have previously been issued public and private keys and that the public keys are available and current. This can make communicating with a new party difficult, if not impossible. In addition, current PKI interfaces require users to understand and appreciate the need for additional security, and for those users to take specific actions to implement the security.

Air-gaps, another security implementation, are created by disconnecting some system components from the Internet. Although air-gaps provide a high level of security, air-gaps allow only those physically present at a facility to access information stored on a disconnected system, thereby defeating the purpose of connecting a system to the Internet. Although conventional time-division sharing implementations of “virtual air gaps” are known (typically involving the shared use of a physical resource, such a disk drive, or a RAM, by two different systems), these conventional implementations are generally regarded as having very weak security, and are rarely used in systems requiring a high degree of trust.

Other proposed solutions to separating trusted entities from untrusted entities require either the use of thin clients or the use of proprietary client software, such as plug-ins, or modifications to vendor network software in order to be compatible with the resource provider. However, such implementations can cause unintended interference with network functionality, and typically impose overly broad resource access restrictions. In addition, such implementations limit hardware, software, and operating system choices to specific platforms, and, due to their proprietary nature, prevent access to resources secured by other schemas.

### SUMMARY OF THE INVENTION

Accordingly, the present invention is directed to a system and method for secure data transmission that substantially obviates one or more of the problems due to limitations and disadvantages of the related art.

An object of the present invention is to provide an improvement in exchanging secure data between resource providers and resource requesters, compared to prior art systems.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in one aspect of the present invention there is provided a system for secure data transmission including a session layer that maps authentication of at least one request to session level authorization, the authorization defining permitted communications between at least one resource and the at least one request.

In another aspect of the present invention there is provided a system for secure data transmission including a virtual air gap provided by a trusted session sub-layer for session authorization and maintenance a trusted operating system for session separation; and a reverse proxy for data transfer between a user and a resource provider.

In another aspect of the present invention there is provided a system for secure data transmission including a trusted session sub-layer maintaining a virtual air gap between a plurality of resource requesters and a plurality of resource providers; a session manager for a transfer of data between the plurality of resource requesters and the plurality of resource providers.

In another aspect of the present invention there is provided a system for secure data transmission including a session layer for a transfer of data between a plurality of resource requesters and a plurality of resource providers, wherein no peer-to-peer connections exist below the session layer; and a trusted session sub-layer maintaining a virtual air gap, wherein no physical resources are time-division shared between any resource provider and any resource requester.

To achieve these and other advantages and in accordance with the purpose of the present invention, as embodied and broadly described, in one aspect of the present invention there is provided a system for secure data transmission including session layer means for mapping authentication of at least one request to session level authorization, the authorization defining permitted communications between at least one resource and the at least one request.

In another aspect of the present invention there is provided a system for secure data transmission including virtual air gap means provided by trusted session sub-layer means for session authorization and maintenance a trusted operating system for session separation, and reverse proxy means for data transfer between a user and a resource provider.

In another aspect of the present invention there is provided a system for secure data transmission including trusted session sub-layer means maintaining a virtual air gap between a plurality of resource requesters and a plurality of resource providers, a session manager for a transfer of data between the plurality of resource requesters and the plurality of resource providers.

In another aspect of the present invention there is provided a system for secure data transmission including session layer means for a transfer of data between a plurality of resource requesters and a plurality of resource providers, wherein no peer-to-peer connections exist below the session layer means, and a trusted session sub-layer maintaining a virtual air gap, wherein no physical resources are time-division shared between any resource provider and any resource requester.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating the architectural difference between the present invention and prior network configurations;

FIG. 2 is a block diagram illustrating differences between a traditional Network Access Point and a Secure Point of Presence;

FIG. 3 is a block diagram illustrating a network protocol architecture implemented as part of the present invention;

FIG. 4 is a process flow diagram providing a high-level overview of steps performed when a resource is requested, from the perspective of the resource requester;

FIG. 5 is a process flow diagram providing a high-level overview of steps performed when a resource is requested, from the perspective of the resource provider;

FIG. 6 is a process flow diagram providing a high-level overview of steps performed by a Secure POP throughout a session lifespan;

FIG. 7 is a diagram illustrating a Secure POP session; and

FIGS. 8-11 illustrate additional embodiments of the present invention.

### DETAILED DESCRIPTION OF THE PREFERRED EMBODIMENTS

Reference will now be made in detail to the preferred embodiments of the present invention, examples of which are illustrated in the accompanying drawings.

A system and method is disclosed by which participating, disparate, independently managed sites may be connected to a non-sterile extranet yet still conduct transactions with a high level of security. Security is implemented by setting up a secure point of-presence using mandatory access controls via trusted operating systems and devices, and allowing parties to connect to it using trusted introducers. Further, network traffic is proxied via the ISO Session layer. Through this implementation, Internet-based resource providers gain a benefit of mandatory access controls without having to set up a trusted infrastructure between parties.

A preferred embodiment of the present invention enforces security policies using a secured point-of-presence (Secure POP) to enforce mandatory access controls. Through the present invention, a resource provider may set forth a security policy which limits access to its resources to only those requests coming from the Secure POP. Thus, to gain access to such resources, a requester must request information from the Secure POP, rather than directly from the resource provider.

To further increase overall security, trusted operating systems and mandatory access controls may be used by the Secure POP to provide security policy enforcement. Through such a configuration, a resource requester need not install additional software or hardware to access the Secure POP. Rather, the Secure POP can handle all security-related issues, thereby reducing deployment costs.

Security is further enhanced by implementing a virtual network “air gap” which disallows all network access between sites. An air gap can allow network resource access requests to be routed through a trusted application, which can enforce security policies with as much rigor as required. Such an implementation may allow for tight resource control and can obviate, but need not prohibit, the use of additional, individual site security mechanisms designed to prevent external access.

A preferred embodiment of the present invention can include a trusted operating system, a trusted database management system, a trusted OSI-session sub-layer, other trusted applications, an audit subsystem, and a root certificate authority subsystem. Unlike conventional security systems, a preferred, trusted OSI Session sub-layer, which prohibits all applications from accessing the network at or below the transport layer, may be implemented. The trusted OSI Session sub-layer may route Internet Protocol (IP) data through the trusted sub-layer atop the OSI Session layer. It will be appreciated that it is possible to implement the invention without the trusted operating system (for example, with an exchange using an encryption key that is communicated using some other method), however, it is believed that such an implementation will not be as secure as an implementation that uses the trusted operating system. Thus, in the preferred embodiment, the virtual air-gap is provided by the combination of the sub-layer to handle session authorization and maintenance, a trusted operating system to provide separation of the various sessions. and a transfer of data within the core that is handled via a pull from the provider side and a push to the subscriber (sometimes called “reverse proxy”).

Traditionally, network applications connect via sockets at the Transport level, and those which have implemented network security have done so by creating their own implementation of higher layers which ride above the modified Transport layer. (In other words, the preferred embodiment creates a new Transport layer connection.) Unlike conventional implementations, the present invention moves the security system up another level in the OSI data model, to the Session layer. (It is worth noting that the Presentation Layer in most modem systems, particularly Internet systems, has essentially disappeared. Thus, in conventional systems, authentication in conventional systems is usually done in the Application Layer, or in the operating system itself.)

In the present invention, only OSI layers above the Transport layer (i.e., the Session layer, in the OSI model) may communicate on a peer level using trusted software. Layers below the Trusted Session sub-layer do not know of each other's existence. This further reinforces the virtual “air gap,” and prevents unauthorized traffic. Thus, in the preferred embodiment, the Session Layer maps the ports to itself, providing authentication and then associates a transport connection.

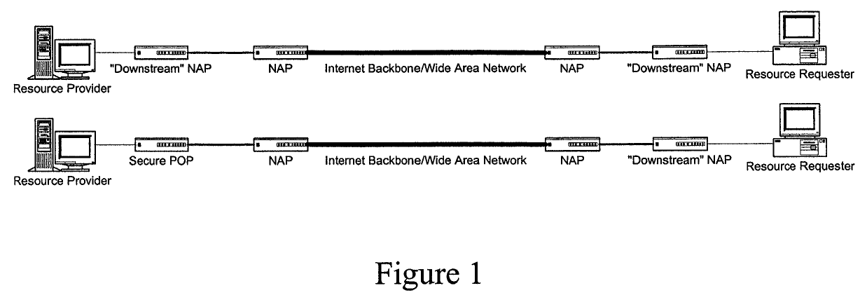

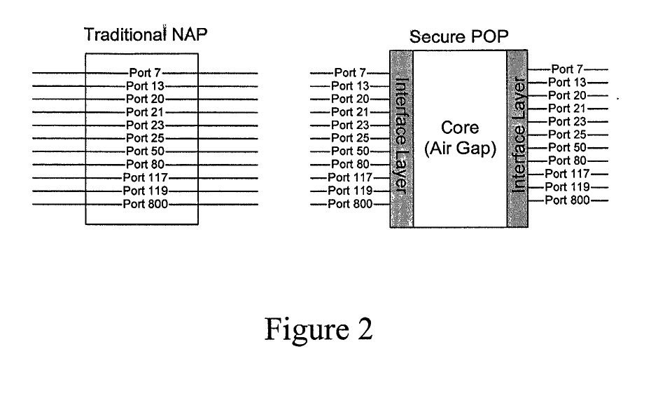

In the preferred embodiment, the centralized access to resources may be provided, as well as inter- and intra-site protection, by adding resource abstraction through the implementation of the Secure POP on the Internet. Such a Secure POP may allow only appropriately introduced and authenticated users to access specified resources. As illustrated in FIGS. 1 and 2, the architecture implemented in the preferred embodiment may be similar to that of a NAP, but some functionality present in a NAP need not be implemented. In the preferred embodiment, NAP functionality that is not implemented includes, for example, network traffic forwarding (although trusted IP forwarding could be implemented as part of the functionality).

To access resources behind the Secure POP, a resource requester can follow a series of functional steps which result in secure transactions with the resource provider. These steps include, but are not limited to, authentication, resource identification, session establishment, secure transactions, and session closure.

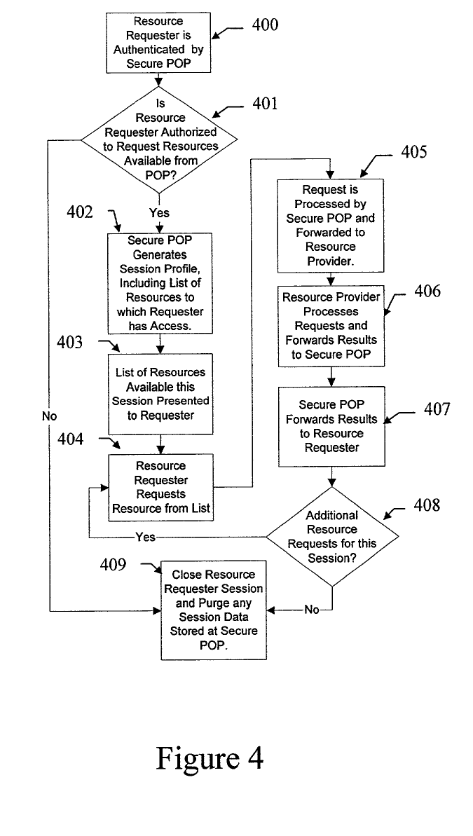

FIG. 4 is a process flow diagram providing a high-level overview of steps performed when a resource is requested, from the perspective of the resource requester. In the preferred embodiment, a resource request may begin with the resource requester identifying himself through a trusted operating system or trusted application (Block 400). Such identification can be used to validate the identities of all requesting parties, provide access without releasing source information, and set up a suite of allowable accesses for a given user session, and for other such purposes. Any available validation system to facilitate identification may be used, as required by the resource provider.

As illustrated by Block 401, in the event the resource requester is unable to adequately identify himself, all connections with the resource requester may be closed, and all data currently stored at the Secure POP regarding the resource requester session may be purged, with the exception of audit records indicating the failed authorization attempt.

Once parties are appropriately introduced and validated, a trusted application can establish access between the Secure POP interface level and internal Secure POP security mechanisms (Block 402). These internal Secure POP security mechanisms (“Secure Core”) may then

The Secure Core can include trusted databases of resource providers available through the generate a user profile referencing the set of expected accesses. Secure POP, as well as pre-established access rules created by resource providers. User and resource profiles can then be combined to create a session profile, which represents a set of accesses that are both allowed and expected for a given user in a given session. Session profile data may then be presented to the resource requester as a list of accessible resources (Block 403). In the preferred embodiment, such a list may mask resource provider identities by allowing the Secure Core to maintain a correspondence list in a protected, trusted application. By masking resource provider identities, increased security is provided compared to a conventional resource list. (This may be referred to as data non-attribution, or location hiding by address masking.)

The resource requester may then select a resource from a list of accessible resources (Block 404). The Secure Core may interpret resource requests and determine where these resources are held, based on the correspondence list. When the resource provider is identified, the Secure Core may establish a session between the resource requester and a specific resource of the resource provider (Block 405). In the preferred embodiment, the Secure Core controls all session aspects; resource requesters and resource providers never communicate directly with each other (Blocks 406 and 407). This creates a virtual “air gap.” The virtual air gap allows the resource requester to conduct any transaction supported by the resource provider, as mediated by a security policy enforced by the Secure Core.

In the preferred embodiment, data received by the Secure POP during a session may be purged by the Secure Core when a session is terminated (Blocks 408 and 409). An alternative embodiment may allow resource providers or pre-existing rules to dictate data lifespans; however, as with the preferred embodiment, all session data may be purged when the session is closed. When a session is terminated, a POP may ensure that the resource requester has returned to a state where another resource request may be made.

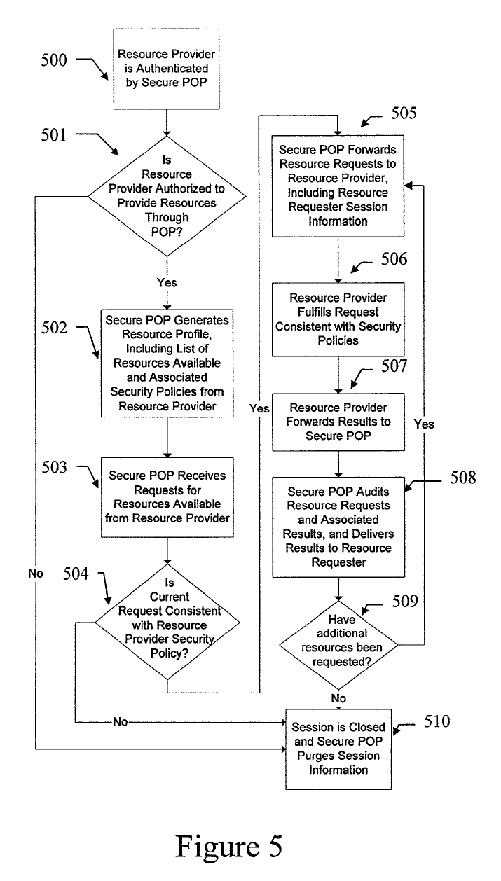

FIG. 5 is a process flow diagram providing a high-level overview of steps performed when a resource is requested, from the resource provider's perspective. In the preferred embodiment, the resource provider may first authenticate itself with the Secure POP (Block 500). If the resource provider is not authorized to provide resources through a given Secure POP, the Secure POP may terminate any communication with the resource provider (Block 501).

If the resource provider is authorized to provide resources through the Secure POP and is properly authenticated, such a resource provider may supply a list of available resources and security policies associated with those resources to the Secure POP. A security policy supplied to the Secure POP may include information such as, but not limited to, specific users and/or user types permitted to access a given resource, and network interfaces through which a user may request such resources. By way of example, without intending to limit the present invention, such a security policy structure may allow the Secure POP to provide a resource to a user connecting via a local area network, but to deny access to the same user if the user connects through a modem. There are numerous ways of identifying the user's location, in addition to the IP address. As an example, the Secure POP could know that when a particular user logs in from a remote site, the remote site is 50 miles away, and therefore, the delay in packet transmission should be no more than, for example, 2 milliseconds. If the transmission delays were considerably longer, the Secure POP would recognize that as an a security breach, and break off the session. Alternatively, the Secure POP may ask for re-authentication, or seek additional authentication from another source.

With appropriate security policies and resource descriptions, the Secure POP may update internal resource and security information to reflect resources provided by newly connected resource providers (Block 502). When such internal information has been properly updated, the Secure POP may begin facilitating communications between the resource requester and the resource provider.

As resource requests are received (Block 503), the Secure POP may record request parameters, such as resource requested, user requesting the resource, and the like, in a database, thus providing an audit record. In addition, the Secure POP may review received requests to ensure that any requests are consistent with security policies established by the resource provider (Block 504). If such request are consistent with such policies, the Secure POP may forward such requests to an appropriate resource provider. In addition to forwarding resource requests, the Secure POP may also forward security information associated with the resource requester session (Block 505).

In some cases, as the resource provider fulfills resource requests (Block 506), bi-directional communication may be necessary. If bi-directional communication is necessary, the Secure POP may establish multiple sessions, with each session operating in a half-duplex manner. Such an arrangement can enforce strict security policy adherence by allowing the Secure POP to create multiple sessions if the resource requester or resource provider requires resources with different security policies.

When the resource provider has collected requested information, the resource provider may forward such information to the Secure POP (Block 507). The Secure POP may then add additional session information to an audit database, and forward results to an appropriate resource requester (Block 508). If additional resource requests have been received by the Secure POP, processing can loop to Block 504, which determines whether requests are consistent with security policies. If additional resources are not requested, the Secure POP may terminate the session and purge all session information, with the exception of audit information. To further enhance security, both internal Secure POP data and data transmitted from or received by the Secure POP may be encrypted. In addition, the preferred embodiment of the present invention may also implement a network protocol with an alternative OSI Session layer.

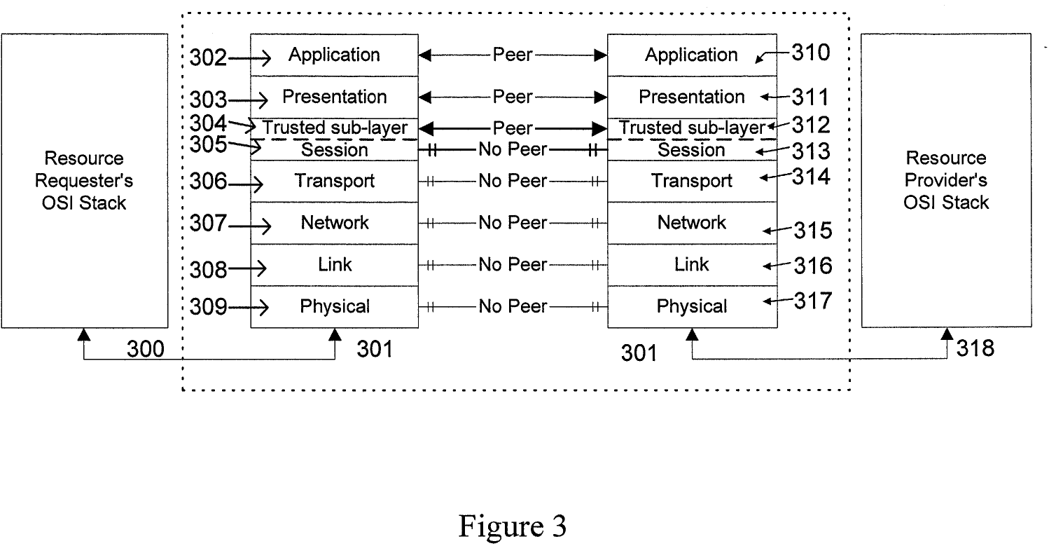

FIG. 3 illustrates OSI stacks for both the resource requester and the resource provider. The resource requester OSI stack (Block 300) may contain seven distinct layers, illustrated by Blocks 302 through 309. The resource provider OSI stack (Block 318) may also contain seven distinct layers, illustrated by blocks 310 through 317. As shown in FIG. 3, in the preferred embodiment, the normal OSI Session layer is modified to include a Trusted Session Sub-Layer (Blocks 304 and 312). The Trusted Session Sub-layer may enforce security by requiring that all network communications from or to applications running on the resource requester or resource provider be authenticated with certain credentials.

To create these credentials, the Trusted Session Sub-layer may “bundle” OSI Transport layer communications between a given resource requester and a given Secure POP. The Trusted Session Sub-layer may then add session profile information to all data transmitted, thereby allowing a receiver to properly authenticate such data. Authentication can include authorization from the resource provider giving a particular session rights to perform specific actions. Such authorization may be provided directly by the resource provider, or the resource provider may allow a trusted third-party to handle such authorization.

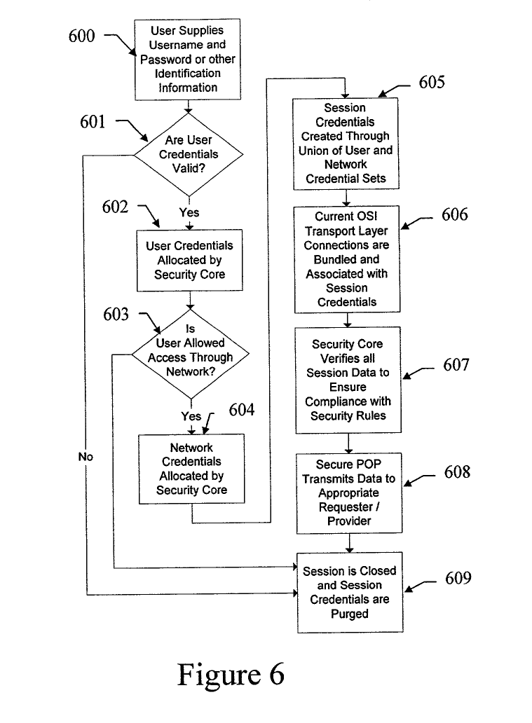

FIG. 6 provides a high-level overview of a process by which such authorization may occur. When an initial resource request is made to a well-known port by a user from a client network, user credentials may be validated (Block 600). If a user has not supplied valid credentials, any open sessions may be closed (Block 601). If a user supplies valid credentials, the Secure Core may create an internal credential set based on supplied user information (Block 602). Such a credential set may include, but is not limited to, a list of resources available to a user, and permissions associated with a user at each resource.

With a user appropriately validated, a network through which a user connects may also be authenticated (Block 603). Additional internal Secure Core credentials may be created based on factors such as, e.g., media type, encryption level, and transmission speed (Block 604). After user and network credentials are created, a set of session credentials may be determined by forming a union of user and network credentials (Block 605). As illustrated by Block 606, current OSI Transport layer connections connected with user communications may then be bundled, and such bundles may be associated with appropriate session credentials. By associating OSI Transport layer connections with session credentials, the Secure Core can enforce resource provider security policies (Block 607).

When data requests are consistent with security policies, the Secure POP may transmit such requests to an appropriate resource provider (Block 608). After all resource requests associated with a given session have been either fulfilled or rejected, the session may be closed and all session credentials and session information may be purged from the Secure POP, except information necessary to maintain an audit trail.

Thus, in the preferred embodiment, the Secure Core may be implemented as a “sterile core.” The sterile core holds no data, except transiently. Therefore, if the Secure Core is breached, no data is available to the attacker. However, an implementation without a sterile core is, of course, also possible.

Another way of looking at the preferred embodiment is as a way to separate networks by instituting a “man-in-the-middle” (MITM) technique to protect data rather than compromise it. However, in order to protect the data, the MITM device has to be trusted both by providing security mechanisms to authenticate from trusted authenticators, and by assuring that communications between parties is kept completely separate. Otherwise a breach of the MITM device would compromise the whole system.

As an example, the following OSI Layers 1-4 Security Mechanisms may be used in the Secure POP:

Layer 1 (Physical layer)—Separation of physical mediums, where necessary.

Layer 2 (Link layer)—Link encryption, when required by policy and for all Inter-Secure POP communications.

Layer 3 (Network layer)—IPSEC mechanisms, where required by policy.

Layer 4 (Transport layer)—TLS Peer-to-Peer mechanisms, where required by policy.

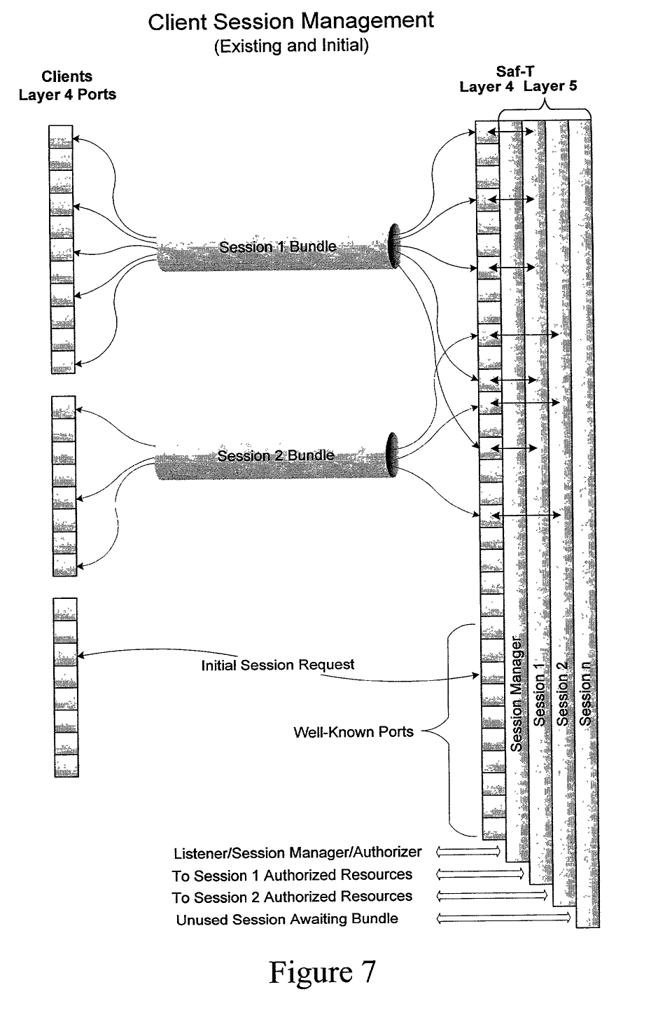

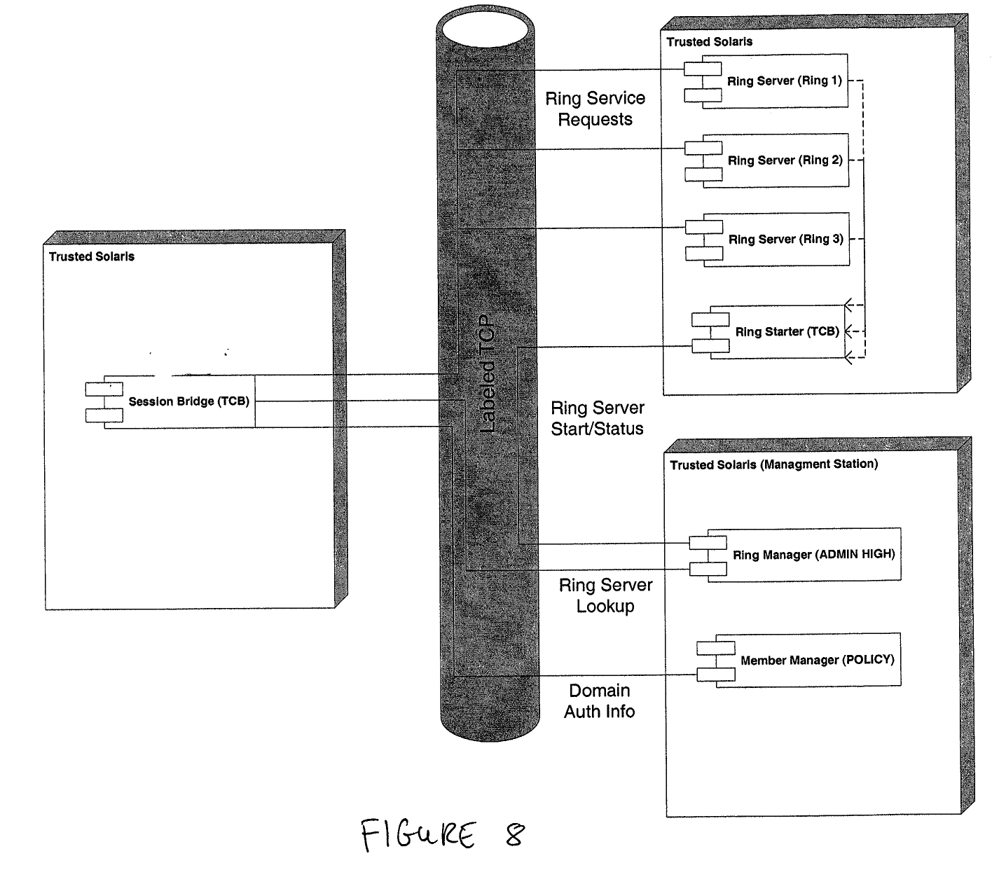

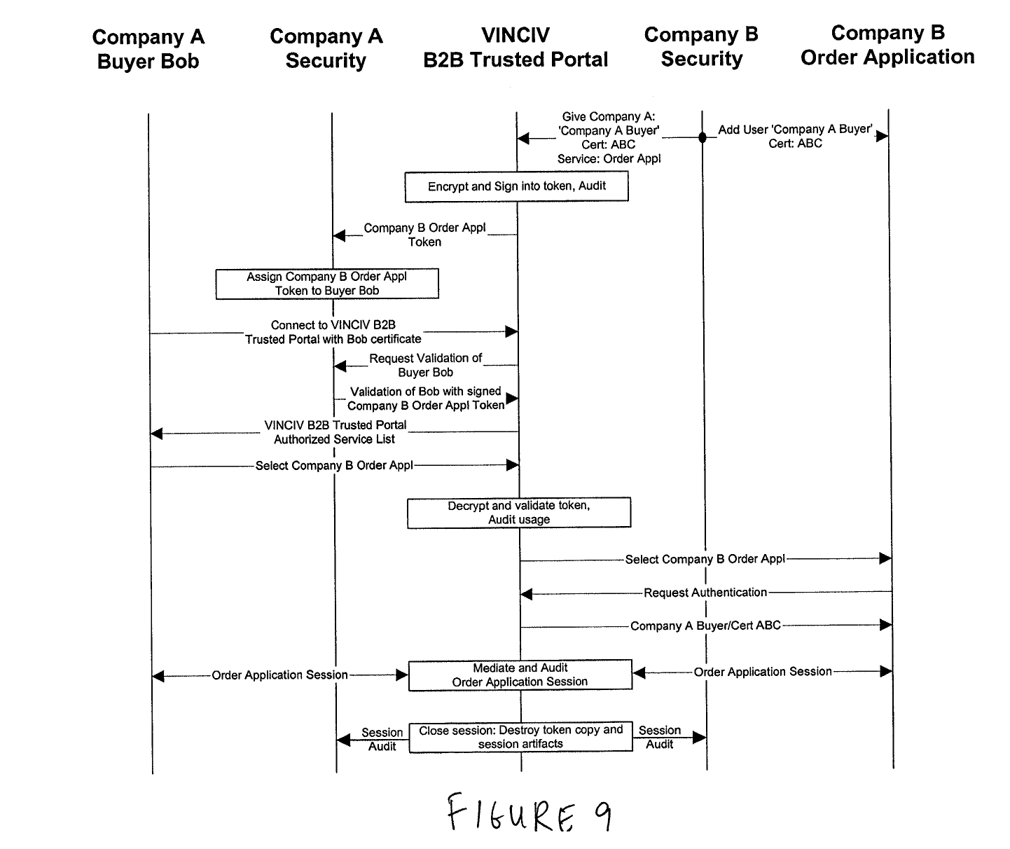

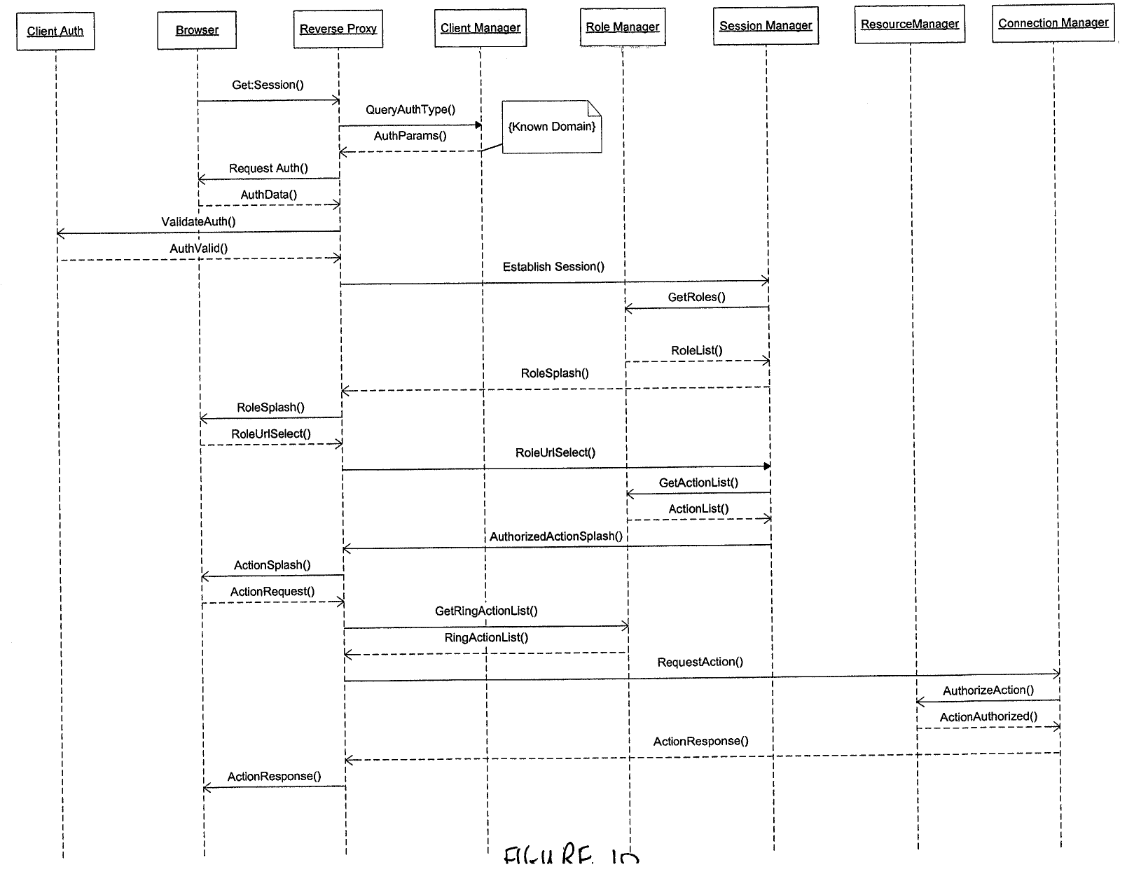

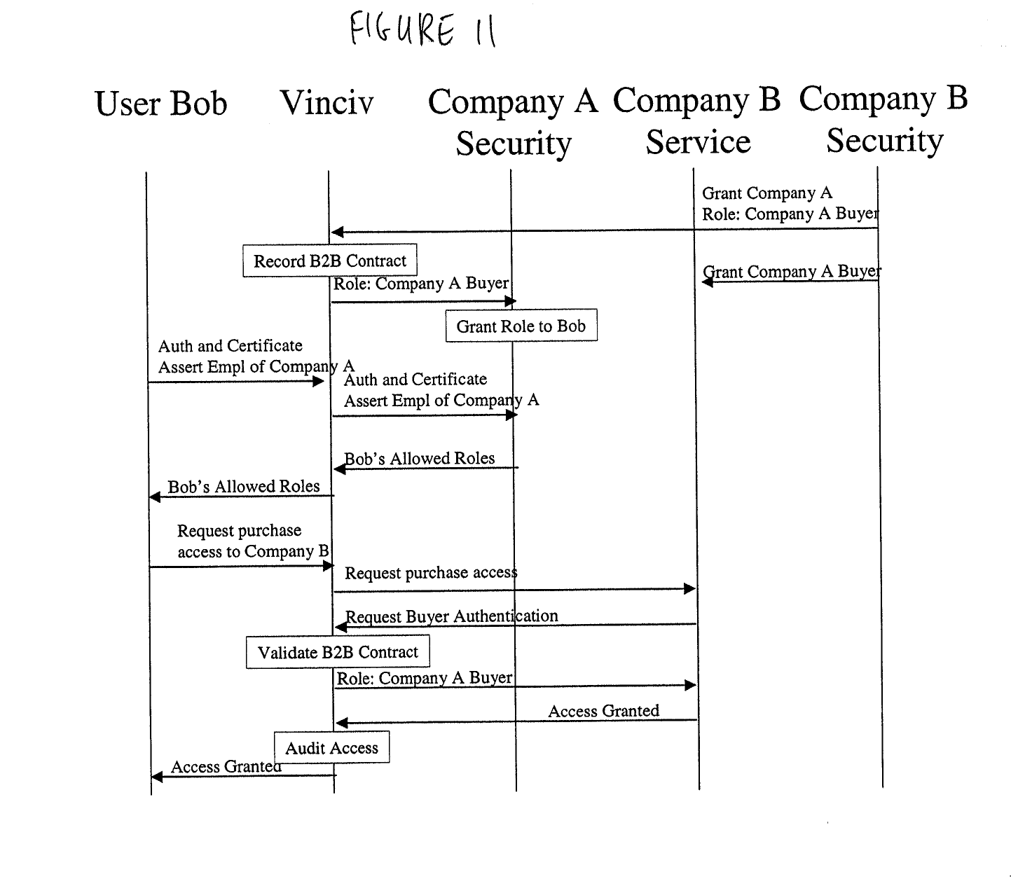

As illustrated in FIG. 7, a bundle is a set of Layer 4 transport connections (commonly known as TCP connections). The bundle is the lowest layer of granularity upon which credentials at Layer 5 (Session layer) are issued. A session may be thought of as a bundle of validated transport connections, which in total is credentialed to provide or receive specific resources. More than one session may be joined with another session to create a meta-session, based on the Secure POP rulebase.

A credential is an authorization from a resource owner that a given entity can perform specified actions on said resource. A resource owner can delegate the right to issue a credential on his resource to a third party. Within the Secure POP, credentials are managed by and around sessions, not individual transport connections.

An initial resource request is made to a well-known port by a user from a client network. First, the user is validated and credentials are allocated (but not issued) using Secure POP, then the network is validated using lower-layer security mechanism and credentials allocated (but not issued) using Secure POP. The set of allocated credentials is then minimized to the smallest set based on the union of the user and network. Mandatory credentials are issued, the OSI Layer 5 session is set up, and transport connections are bundled and attached to the session. (See FIG. 7.)

A packet from the network will come in from an existing bundle with the form IPADDR:PORT:DATA which corresponds to an address of a resource. The Secure POP decides what to do with this resource, based on the Secure POP rulebase, the set of credentials given to the session, and thus the bundle. This amounts to credential-based resource filtering.

Any given session may accumulate credentials as required to access resources as long as those credentials are authorized by the rulebase. This would happen as follows:

The session starts with two credentials: the user and network, which when combined provide the set of authorized, but not necessarily granted, credentials. Resources can grant temporary credentials based on the above set of authorized credentials.

For example, consider the workflow required to close a mortgage. This process requires specific tasks that are “checked off” on completion by either the seller, the buyer, or a third party. A partial set of rules may consist of:

Class Buyer:

Required: (background investigation, bank statement, credit check, employer check, type of loan [exclusive(VA, FHA, Commercial, . . . )], . . . )

Options: (warranty)

Time Window: (30 days)

Class Seller:

Required: (title search, liens investigation, property inspection, bank account, . . . )

Options: (warranty, type of loan [inclusive: (Allow FHA, Allow Commercial)] . . . )

Once each of the required and selected optional objects are certified within the optional time window, the class is set as fully credentialed. Additionally, the objects within the class can themselves be a class that also requires objects and will not be certified until all of the contained objects are certified:

Class FHA:

Required: (Tax Returns, Flood Insurance, Down Payment . . . )

Once the complete set of credentials are collected for both the buyer and the seller, the transaction is complete and funds may be transferred. It will be appreciated from this example that the preferred embodiment allows for dynamic authorizations, with additional authorizations (and/or connections) coming into existence as the session goes on. A static (rather than dynamic) implementation is, of course, also possible.

In the preferred embodiment, an initial resource request for an application is made to a well-known port by an object (user or automaton) from a client network. Rather than individual applications directly listening to well-known ports, a single application, the Session Manager, listens on all ports. The Session Manager then requests authentication via an external process (details omitted in this discussion), and determines the network source of the request. If the authentication is successful, the Session Manager queries the Secure POP rulebase to determine those resources that are authorized for this client using the session authentication pair (object A on network B). Since an authentication pair is used, mandatory access controls can be applied based on an object and it's location. For example, a user at her office can be given a different set of resources than the same user at her home.

Once the set of resources for a client is determined, a session with this client is set up to handle the request and any other requests, along with a series of ports mapped exclusively for this session. The series of requests and transactions for various resources between a client and his exclusive ports is therefore the “bundle” discussed above. The bundle lasts for the life of the session.

From this point on, the Session Manager spawns all requested resources authorized for that bundle. Note that once the session bundle is established, the client no longer needs to be authenticated for other approved resources.

In another preferred embodiment, the system performs similarly to the preferred embodiment that uses the OSI protocol. The difference is that the Session Manager is added to Layer 5 (Session layer) and communicates through higher OSI layers rather than directly to applications.

In yet another preferred embodiment, a Multi-level Operating System is used as proxy. Most networks operate at a single security level (“system high”) using Discretionary Access Controls (DAC). It may be necessary to communicate between two networks with differing security requirements, thus necessitating the use of Mandatory Access Controls (MAC). A multi-level operating system applies MAC in a hierarchical fashion. By keeping activities on each network segregated and using a trusted proxy, MAC can be enforced between the two networks.

A trusted operating system is set up on a device with two network interface cards. The Session Manager is placed on each network interface. Each produces bundles between clients and resources on its respective network, as described in the first preferred embodiment. Session Manager A, rather than spawning resources directly, spawns “listener” and “request” processes at a higher security level to communicate with session manager B on the other interface, that similarly had spawned processes at a higher level. Resources are then retrieved by the Session Manager A on behalf of the client via session manager B, which drops down to network B's security level, retrieves the resource, drops down to a lower level and delivers the resource to A. Clients never need traverse each other's network. This method can be extended to any arbitrary number of network interfaces at differing or same levels, provided that mechanisms within the trusted OS work both above and below the network levels.

Through the system and method described above, the present invention facilitates secure data access through the Internet or other data network. The present invention can further strengthen security by implementing an alternative OSI Session layer as described above. It will also be appreciated by one of ordinary skill in the art that the embodiments described in this application may be supplied as stand-alone software, and distributed either on tangible media (such as floppy disks, CD-ROM's, etc.), or electronically, such as over the Internet or Local Area Networks. Alternatively, the system may be supplied in the form of a semiconductor chip, added to networked computers, for example, as a plug-in card.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A system for secure data transmission comprising:
a session layer that maps authentication of at least one request to session level authorization, the authorization defining permitted communications between at least one resource and the at least one request.

2. The system of claim 1, wherein the session layer includes:
a trusted session sub-layer for session level authorization and maintenance; and
a reverse proxy for transferring data between the at least one resource and the at least one request.

3. The system of claim 2, wherein layers of the request below its trusted session sub-layer are unaware of existence of layers of the resource below its trusted session sub-layer.

4. The system of claim 1, wherein the session layer forms a bundle of transport layer connections between the at least one resource and the at least one request.

5. The system of claim 4, wherein a plurality of bundles of transport layer connections are joined to create a meta-session.

6. The system of claim 1, wherein the session layer maps ports onto itself.

7. The system of claim 6, wherein the session layer associates a transport connection for data to pass from the at least one resource to the at least one request.

8. The system of claim 1, further including a trusted operating system.

9. The system of claim 1, wherein the authorizations are dynamically updated.

10. The system of claim 1, wherein no layer below the session layer communicates on a peer to peer level.

11. The system of claim 1, wherein the session layer includes a sterile core.

12. The system of claim 1, wherein the session layer maps the authentication of users using a Secure Core rulebase.

13. The system of claim 1, wherein resource identities are masked.

14. The system of claim 1, wherein the authorization is dependent on a network interface of the at least one request.

15. The system of claim 1, wherein the session layer provides an audit trail.

16. The system of claim 1, wherein the session layer can establish multiple sessions with multiple requests, each session operating in a half-duplex manner.

17. The system of claim 1, wherein the session layer mediates resources between the at least one request and the at least one resource based on a credential set.

18. The system of claim 1, wherein the session layer mediates resources between the at least one request and the at least one resource based on a credential set, and
wherein the session layer bundles transport layer communications between the at least one resource and the at least one request by associating the bundles with the credential set.

19. The system of claim 1, further including a multi-level operating system used as a proxy.

20. The system of claim 1, further including a Session Manager to communicate through higher OSI layers.

21. The system of claim 1, wherein no physical resource is time-division shared by the at least one resource requester and the at least one resource provider.

22. A system for secure data transmission comprising:
a virtual air gap provided by:
a trusted session sub-layer for session authorization and maintenance;
a trusted operating system for session separation; and
a reverse proxy for data transfer between a user and a resource provider.

23. The system of claim 22, wherein layers of the user below its trusted session sub-layer are unaware of existence of layers of the resource provider below its trusted session sub-layer.

24. The system of claim 22, wherein the trusted session sub-layer forms a bundle of transport layer connections between the user and the resource provider.

25. The system of claim 24, wherein a plurality of bundles of transport layer connections are joined to create a meta-session.

26. The system of claim 22, wherein a session layer, which includes the trusted session sub-layer, maps ports onto itself.

27. The system of claim 22, wherein the session authorization is dynamically updated.

28. The system of claim 22, wherein no layer below a session layer, which includes the trusted session sub-layer, communicates on a peer to peer level.

29. The system of claim 22, wherein the trusted session sub-layer maps user authentication using a Secure Core rulebase.

30. The system of claim 22, wherein the session authorization is dependent on network interface of the user.

31. The system of claim 22, wherein the trusted session sub-layer mediates resources between the user and the resource provider based on a credential set.

32. The system of claim 22, wherein the trusted session sub-layer mediates resources between the user and the resource provider based on a credential set, and
wherein the trusted session sub-layer bundles transport layer communications between the user and the resource provider by associating the bundles with the credential set.

33. The system of claim 22, further including a multi-level operating system used as a proxy.

34. The system of claim 22, further including a Session Manager to communicate through higher OSI layers.

35. The system of claim 22, wherein no physical resource is time-division shared by the user and the resource provider.

36. A system for secure data transmission comprising:
a trusted session sub-layer maintaining a virtual air gap between a plurality of resource requesters and a plurality of resource providers;
a session manager for a transfer of data between the plurality of resource requesters and the plurality of resource providers.

37. The system of claim 36, wherein the trusted session sub-layer includes a reverse proxy for transferring data between the plurality of resource requesters and the plurality of resource providers.

38. The system of claim 36, wherein the trusted session sub-layer forms a bundle of transport layer connections between the plurality of resource requesters and the plurality of resource providers.

39. The system of claim 38, wherein a plurality of bundles of transport layer connections are joined to create a meta-session.

40. The system of claim 36, wherein the trusted session sub-layer maps ports onto itself.

41. The system of claim 40, wherein the trusted session sub-layer associates transport connections for data to pass from the plurality of resource requesters to the plurality of resource providers.

42. The system of claim 36, wherein authorizations for the plurality of resourece requesters are dynamically updated.

43. The system of claim 36, wherein no layer below a session layer, which includes the trusted session sub-layer, communicates on a peer to peer level.

44. The system of claim 36, wherein the session layer mediates resources between the plurality of resource requesters and the plurality of resource providers based on each resource requester's credential set, and
wherein the session layer bundles transport layer communications between the plurality of resource requesters and the plurality of resource providers by associating the bundles with the each resource requester's credential set.

45. The system of claim 36, wherein no physical resource is time-division shared by the plurality of resource requesters and the plurality of resource providers.

46. A system for secure data transmission comprising:
a trusted session sub-layer for peer-to-peer communication between a plurality of resource requesters and a plurality of resource providers;
a rulebase for authenticating authorization of the plurality of resource requesters on a dynamic basis,
wherein the trusted session sub-layer forms a bundle of transport layer connections between the plurality of resource providers and the plurality of resource requesters.

47. The system of claim 46, wherein the trusted session sub-layer includes a reverse proxy for transferring data between the plurality of resource requesters and the plurality of resource providers.

48. The system of claim 46, wherein layers of each resource requester below its trusted session sub-layer are unaware of existence of layers of each resource provider below its trusted session sub-layer.

49. The system of claim 46, wherein the trusted session sub-layer maps ports onto itself.

50. The system of claim 46, wherein the authorizations for each resource requester are dynamically updated.

51. The system of claim 46, wherein no layer below the session layer communicates on a peer to peer level.

52. The system of claim 46, wherein the session layer mediates resources between the plurality of resource requesters and the plurality of resource providers based on each user's credential set, and
wherein the session layer bundles transport layer communications between the plurality of resource requesters and the plurality of resource providers by associating the bundles with the each user's credential set.

53. A system for secure data transmission comprising:
a session layer for a transfer of data between a plurality of resource requesters and a plurality of resource providers,
wherein no peer-to-peer connections exist below the session layer; and
a trusted session sub-layer maintaining a virtual air gap,
wherein no physical resources are time-division shared between any resource provider and any resource requester.

54. A system for secure data transmission comprising:
session layer means for mapping authentication of at least one request to session level authorization, the authorization defining permitted communications between at least one resource and the at least one request.

55. A system for secure data transmission comprising: virtual air gap means provided by:
trusted session sub-layer means for session authorization and maintenance;
a trusted operating system for session separation; and
reverse proxy means for data transfer between a user and a resource provider.

56. A system for secure data transmission comprising:
trusted session sub-layer means maintaining a virtual air gap between a plurality of resource requesters and a plurality of resource providers;
session manager means for transferring data between the plurality of resource requesters and the plurality of resource providers.

57. A system for secure data transmission comprising:
trusted session sub-layer means for peer-to-peer communication between a plurality of resource requesters and a plurality of resource providers;
a rulebase for authenticating authorization of the plurality of resource requesters on a dynamic basis,
wherein the trusted session sub-layer means forms a bundle of transport layer connections between the plurality of resource providers and the plurality of resource requesters.

58. A system for secure data transmission comprising:
session layer means for a transfer of data between a plurality of resource requesters and a plurality of resource providers,
wherein no peer-to-peer connections exist below the session layer means; and
trusted session sub-layer means maintaining a virtual air gap,
wherein no physical resources are time-division shared between any resource provider and any resource requester.

59. A computer program product for secure data transmission comprising:
a computer usable medium having computer readable program code means embodied in the computer usable medium for causing an application program to execute on a computer system, the computer readable program code means comprising:
computer readable program session layer code means for mapping authentication of at least one request to session level authorization, the authorization defining permitted communications between at least one resource and the at least one request.

60. A computer program product for secure data transmission comprising:
a computer usable medium having computer readable program code means embodied in the computer usable medium for causing an application program to execute on a computer system, the computer readable program code means comprising:
computer readable program code means for a virtual air gap provided by:
computer readable program code trusted session sub-layer means for session authorization and maintenance;
a trusted operating system for session separation; and
computer readable program code reverse proxy means for data transfer between a user and a resource provider.

61. A computer program product for secure data transmission comprising:
a computer usable medium having computer readable program code means embodied in the computer usable medium for causing an application program to execute on a computer system, the computer readable program code means comprising:
computer readable program code trusted session sub-layer means for maintaining a virtual air gap between a plurality of resource requesters and a plurality of resource providers;
computer readable program code session manager means for transferring data between the plurality of resource requesters and the plurality of resource providers.

62. A computer program product for secure data transmission comprising:
a computer usable medium having computer readable program code means embodied in the computer usable medium for causing an application program to execute on a computer system, the computer readable program code means comprising:
computer readable program code trusted session sub-layer means for peer-to-peer communication between a plurality of resource requesters and a plurality of resource providers;
a rulebase for authenticating authorization of the plurality of resource requesters on a dynamic basis,
wherein the trusted session sub-layer means forms a bundle of transport layer connections between the plurality of resource providers and the plurality of resource requesters.

63. A computer program product for secure data transmission comprising:
a computer usable medium having computer readable program code means embodied in the computer usable medium for causing an application program to execute on a computer system, the computer readable program code means comprising:
computer readable program code session layer means for transferring data between a plurality of resource requesters and a plurality of resource providers,
wherein no peer-to-peer connections exist below the computer readable program code session layer means; and
computer readable program code trusted session sub-layer means for maintaining a virtual air gap,
wherein no physical resources are time-division shared between any resource provider and any resource requester.

64. A method for secure data transmission comprising:
mapping authentication of at least one request to session level authorization in a session layer, the authorization defining permitted communications between at least one resource and the at least one request.
